(19) United States
(12) Patent Application Publication
(10) Pub. No.: US 2023/0351355 A1
(43) Pub. Date: Nov. 2, 2023

(54) CLOUD-BASED CONTACTLESS VENDING MACHINE

(71) Applicant: 6Success, Aliso Viejo, CA (US)

(72) Inventors: Bahar Ahmadi, Irvine, CA (US); Maryam Etminan, Irvine, CA (US)

(21) Appl. No.: 18/139,594

(22) Filed: Apr. 26, 2023

Related U.S. Application Data
(60) Provisional application No. 63/335,242, filed on Apr. 27, 2022.

(51) Int. Cl. G06Q 20/20; G06Q 20/18

(52) U.S. Cl. CPC G06Q 20/203; G06Q 20/18; G06Q 20/208

(57) ABSTRACT

A vending machine has an inventory storage container holding raw materials therein, a mixer, a dispenser, and a reader. A mobile device generates a code for the reader. A server connects with the vending machine over a network, the server having memory for storing computer instructions and a processor for executing the computer instructions, the computer instructions including instructions for implementing an operations management application for controlling the operations of the vending machine with a temperature control module for controlling the temperature of the vending machine. The mobile device communicates to code to the vending machine reader to activate the vending system to send raw material from the inventory storage container to the mixing to form a mixture therein and to send the mixture to the dispenser for dispensing therefrom.

### CROSS REFERENCE TO RELATED APPLICATION

This application claims the benefit under 35 U.S.C. § 119(e) of U.S. Provisional Application No. 63/335,242 entitled “CLOUD-BASED CONTACTLESS VENDING MACHINE” filed Apr. 27, 2022, which is incorporated herein by reference.

### BACKGROUND

The preparation and dispensation of food and beverages is a predominantly human-mediated process. Preparing meals, snacks, beverages, etc. is a time-consuming process subject to imprecision due to variations introduced by the human preparer (e.g. measurement inaccuracy, imprecise heating, timing of operations such as heating, marinating, mixing, blending, etc.). These limitations can be overcome with the limited degree of automation or assistance that can provided through conventional coffee/espresso machines, vending machines, smoothie machines, and other similar machines.

Indeed, vending machines and smoothie machines are well known. Unfortunately, it is difficult to combine these types of machines because smoothies must be in constant mix to maintain the desired consistency of the suspension. Further, it is difficult to produce multiple flavors of smoothies.

Accordingly, it would be of great advantage to provide systems and techniques for combining the advantages of vending machines and smoothie machines in a manner that provides greater availability, precision and accuracy to the process, and avoid safety concerns, all the while conserving space and cost of a system capable of performing a wide variety of tasks useful in the context of smoothie preparation and dispensation.

### SUMMARY

The following summary is provided to introduce a selection of concepts in a simplified form that are further described below in the detailed description. This summary is not intended to identify key features or essential features of the claimed subject matter, nor is it intended to be used to limit the scope of the claimed subject matter.

In various implementations, a vending machine system includes a vending machine having an inventory storage container holding raw materials therein, a mixer, a dispenser, and a reader. A mobile device generates a code for the reader. A server connects with the vending machine over a network, the server having memory for storing computer instructions and a processor for executing the computer instructions, the computer instructions including instructions for implementing an operations management application for controlling the operations of the vending machine with a temperature control module for controlling the temperature of the vending machine. The mobile device communicates to code to the vending machine reader to activate the vending system to send raw material from the inventory storage container to the mixing to form a mixture therein and to send the mixture to the dispenser for dispensing therefrom.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1 is a perspective view of a vending machine in accordance with the subject disclosure.

FIG. 2 is a block diagram of a cloud-based vending machine system in accordance with the subject disclosure.

FIG. 3 illustrates an exemplary interface for a mobile device in accordance with this disclosure.

FIG. 4 illustrates exemplary output for a mobile device in accordance with this disclosure.

FIG. 5 is an exemplary process in accordance with the subject disclosure.

FIG. 6 is an exemplary mobile device in accordance with the subject disclosure.

FIG. 7 is an exemplary computing device in accordance with the subject disclosure.

FIG. 8 is an exemplary cloud computing system in accordance with the subject disclosure.

### DETAILED DESCRIPTION

The subject disclosure is directed to a cloud-based contactless vending machine and, more particularly, to a smoothie vending machine that can be activated via a mobile device and controlled by a cloud-based server system. The vending machine is particularly adapted to dispense liquid mixtures in the form of smoothies.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

References to a “module”, “a software module”, and the like, indicate a software component or part of a program, an application, and/or an app that contains one or more routines. One or more independently modules can comprise a program, an application, and/or an app.

References to an “app”, an “application”, and a “software application” shall refer to a computer program or group of programs designed for end users. The terms shall encompass standalone applications, thin client applications, thick client applications, web-based applications, such as a browser, and other similar applications.

References to “Internet of Things” or “IoT” shall refer to smart systems and/or devices comprised of physical objects that are embedded with sensors, processing ability, software, and other technologies, and that connect and exchange data with other devices and systems over the Internet or other communications networks. The systems can represent a convergence of multiple technologies, including ubiquitous computing, commodity sensors, increasingly powerful embedded systems, and machine learning.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

The subject disclosure is directed to a cloud-based contactless vending machine system that utilizes IoT technology to control the operations thereof, track inventory, and analyze transactions. The system was developed in response to various challenges that occurred during the COVID-19 pandemic, namely food provider exposure, public exposure, and the lack of quick access to healthy food to increase resistance to disease.

The system limits the contagiousness of infection, bacteria, and viruses. The system utilizes an end to end contactless vending machine configured for contactless payment. The vending machine can provide a healthy snack and/or a healthy meal quickly. The snacks and/or meals can include various ingredients, such as frozen fruits or vegetables, protein, probiotics, vitamins, minerals, or other nutritional supplements.

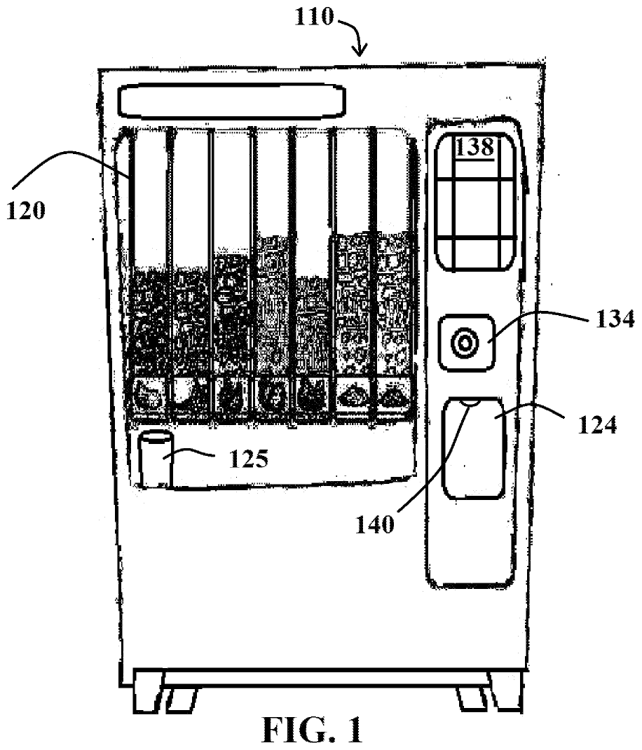

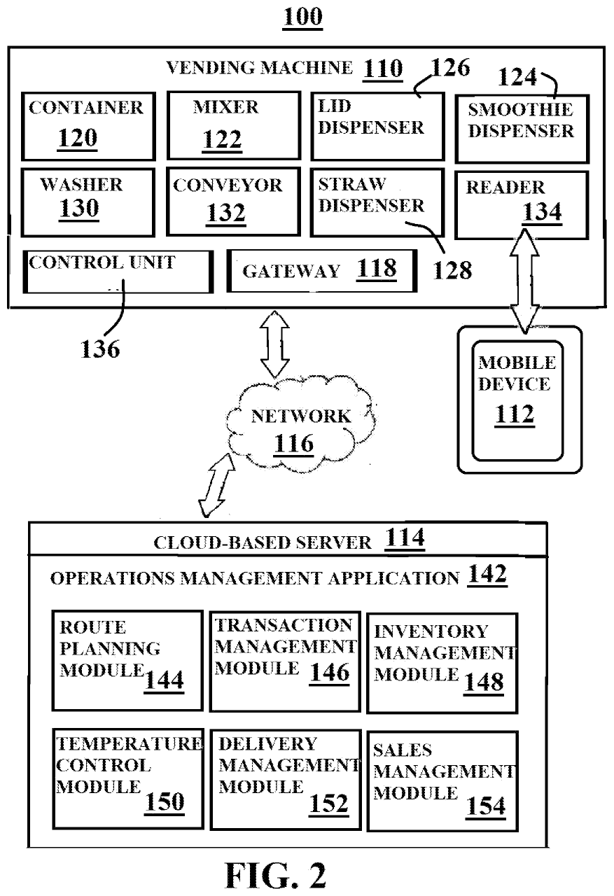

Referring to FIGS. 1-2, a vending machine system, generally designated by the numeral 100, is shown. The vending machine system 100 includes a vending machine 110, a mobile device 112, and a server 114. The vending machine 110 connects to the server 114 over a network 116 through a gateway 118. In this exemplary embodiment, the gateway 118 can be an IOT gateway. The mobile device 112 can be any type of computing device, including a smartphone, a handheld computer, a tablet, a PC, or any other client device.

The vending machine 110 includes an inventory storage container 120 for holding raw materials or smoothie ingredients therein. The environment within the container 120 can be controlled by the server 114. In this exemplary embodiment, the container 120 includes a temperature-controlled and humidity-controlled freezer.

The vending machine 110 includes a blender or mixer 122 for mixing the smoothie ingredients to form a smoothie in the form of a mixture. The vending machine 110 further includes a dispenser 124 for dispensing or pouring the smoothie into a container 125. The vending machine 110 can include a lid dispenser 126 for cover the container and a straw dispenser 128 for inserting a straw through the lid into the container 125.

The vending machine 110 can include a washer 130 for cleaning the mixer 122 and/or the dispenser 124. The vending machine 110 can include a conveying device or conveyor 132 for moving the container 125 through the vending machine 110.

The vending machine 110 can be activated by the mobile device 112 generating a code that can be read by a reader 134 connected to the vending machine 110. In this exemplary embodiment, the mobile device 112 generates a Q-code for display thereon. The reader 134 can read the Q-code to activate the vending machine 110 to make the smoothie.

The vending machine 110 can include a local controller 136 for storing instructions that are received from the server 114 over the network 116. The controller 136 can store software applications, such as HELFIT software, thereon. The vending machine 110 can also include an ad screen 138 and a lamp 140.

As shown in FIG. 2, the operation of the vending machine 110 can be controlled by an operations management software application 142 residing thereon. The operations management software application 142 can include various components or modules, such as a route planning module 144, a transaction management module 146, an inventory management module 148, a temperature control module 150, a delivery management module 152, and a sales management module 154.

The route planning module 144 can develop a route for suppliers to deliver raw materials to the vending machine 110. The route planning module 144 can be configured to optimize routes or otherwise generate routes for the suppliers.

The transaction management module 146 can track financial transactions relating to the use of the vending machine 110. The transaction management module 146 can cooperate with the inventory management module 148 and/or the delivery management module 152 to track inventory and to ensure that the vending machine 110 is properly supplied.

The temperature control module 150 can control the temperature of the vending machine 110 and, in particular, the inventory storage container 120. The temperature control module 150 can be configured to control other environmental conditions of the container 120, such as humidity.

The sales management module 154 can perform various sales or marketing functions. These functions can include performing customer analysis and/or managing customer loyalty programs. In some embodiments, the sales management module 154 can be used with the transaction management module 146 and/or the inventory management module 148 to generate output or reports that includes sales analytics or other tools for analyzing the marketing and/or sales of the products from the vending machines.

Network 116 can be implemented by any type of network or combination of networks including, without limitation: a wide area network (WAN) such as the Internet, a local area network (LAN), a Peer-to-Peer (P2P) network, a telephone network, a private network, a public network, a packet network, a circuit-switched network, a wired network, and/or a wireless network. Computer systems and/or computing devices can communicate via network 116 using various communication protocols (e.g., Internet communication protocols, WAN communication protocols, LAN communications protocols, P2P protocols, telephony protocols, and/or other network communication protocols), various authentication protocols, and/or various data types (web-based data types, audio data types, video data types, image data types, messaging data types, signaling data types, and/or other data types).

Referring now to FIGS. 1-2 with continuing reference to the foregoing figures, an exemplary interface, generally designated by the numeral 300, and exemplary output, generally designated by the numeral 310, for a mobile app is shown. The mobile app can be configured to connect with a vending machine, such as vending machine 110, shown in FIGS. 1-2. The mobile app can reside on the mobile device 112 shown in FIGS. 1-2.

The interface 300 can include a plurality of buttons 312-316 that allow a user to select various smoothie ingredients, so that a smoothie can be made to order. The ingredients can include frozen fruits or vegetables, protein, and other ingredients. Further, the ingredients can include probiotics as a live culture. The interface 300 can be configured to scroll more buttons (not shown) to provide the ability to select a wide assortment of ingredients.

The app can be configured to provide a user with the ability to register himself or herself by scanning a code. The app can be configured to provide a user with the ability to make contactless payment for orders via Apple pay or other touchless payment methods by clicking on a payment or checkout icon 318. In some embodiments, the app can provide the user with the ability to search and to find the nearest vending machine.

The app can include indicators that indicate connection status 320 and/or beverage calorie content 322 based upon the ingredients that are selected with the buttons 312-316. The app can generate a Q-code 324 to activate a vending machine, such as the vending machine 110 shown in FIGS. 1-2.

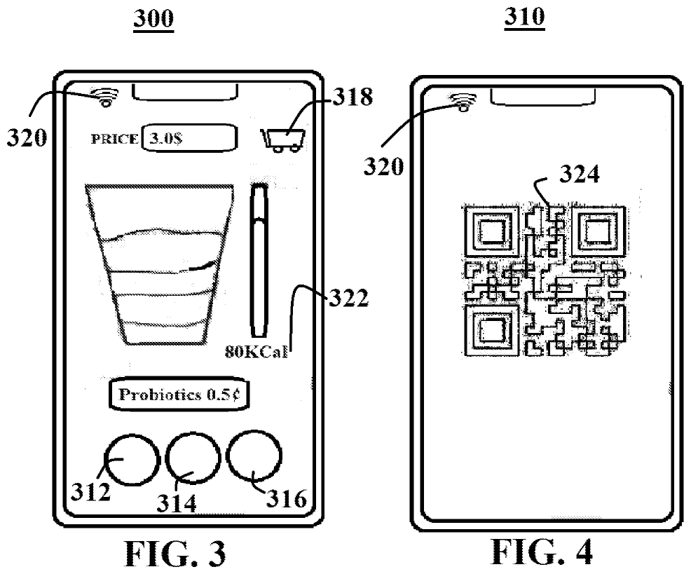

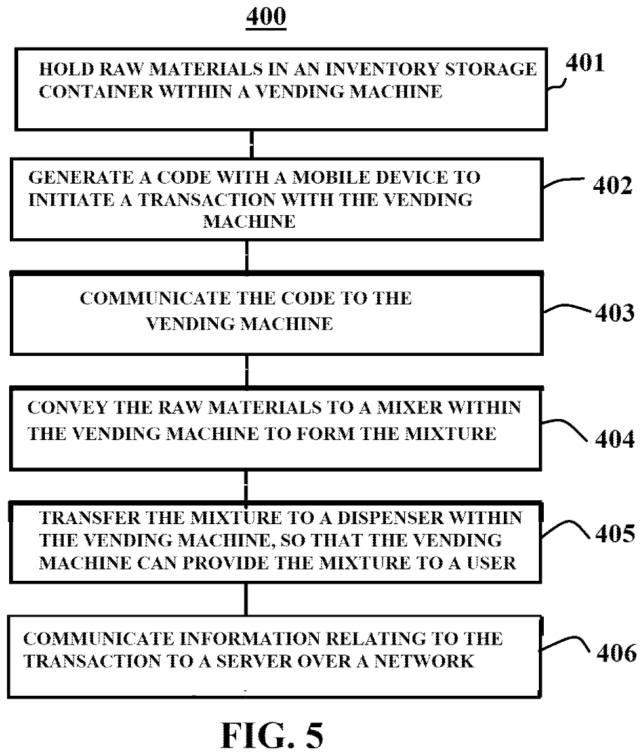

Referring to FIG. 5 with continuing reference to the foregoing figures, an exemplary process, generally designated by the numeral 400, for dispensing a smoothie mixture from a vending machine system is shown. The process 400 can be a performed within the system 100 shown in FIGS. 1-2 and using the interface 300 shown in FIG. 3 to generate the output 310 shown in FIG. 4.

At 401, raw materials for make smoothies are held in an inventory storage container within a vending machine. In this exemplary embodiment, the ingredients can be held within the container 120 in the vending machine 110 shown in FIGS. 1-2.

At 402, a code is generated with a mobile device to initiate a transaction with the vending machine. In this exemplary embodiment, the mobile device can be the mobile device 112 shown in FIG. 2 generating the Q-Code 324 shown in FIG. 4.

At 403, the code is communicated to the vending machine. In this exemplary embodiment, the code can be communicated from the mobile device 112 shown in FIG. 2 to the reader 134 shown in FIGS. 1-2.

At 404, the raw materials can be conveyed to a mixer within the vending machine to form the mixture. In this exemplary embodiment, the mixer can be the mixer 122 shown in FIG. 2. The ingredients can be conveyed via the conveyor 132 shown in FIG. 2.

At 405, the mixture can be transferred to a dispenser within the vending machine, so that the vending machine can provide the mixture to a user. In this exemplary embodiment, the dispenser can be the smoothie dispenser 124 shown in FIGS. 1-2.

At 406, information relating to the transaction can be communicated to a server over a network. In this exemplary embodiment, the server can be the cloud-based server 114 shown in FIG. 2. The network can be the network 116 shown in FIG. 2.

### Exemplary Mobile Device

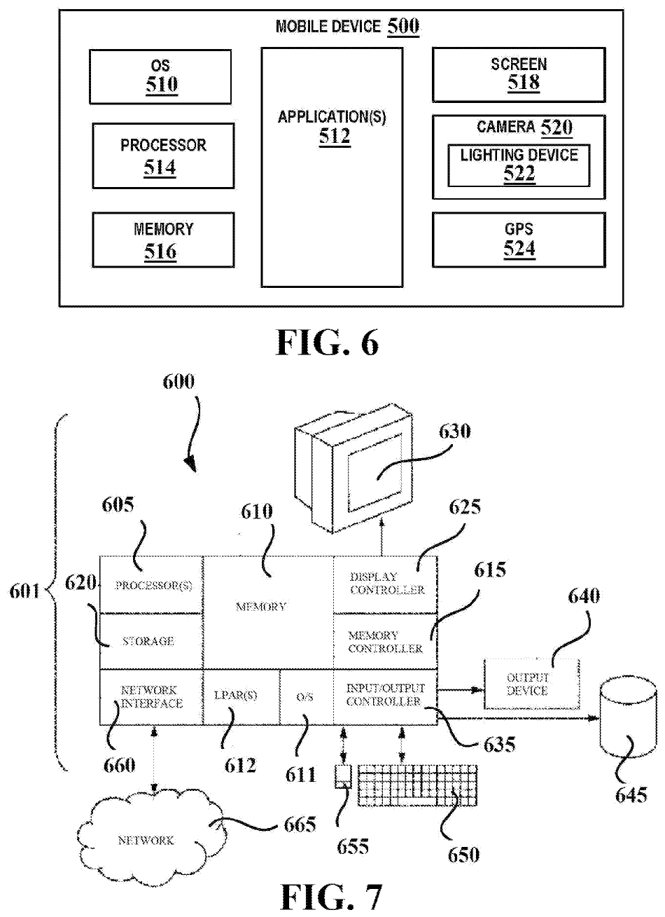

Referring now to FIG. 6 with continuing reference to the foregoing figures, an exemplary mobile device, generally designated by the numeral 500, is shown. The mobile device 500 can be the mobile device 112 shown in FIG. 2.

Mobile device 500 can include operating system 510 and various types of mobile application(s) 512. In some implementations, mobile application(s) 512 can include one or more client application(s) and/or components of a client application. In this exemplary embodiment, one of the mobile applications 512 can be an app that allows a user to select various smoothie ingredients, order a smoothie, pay for the smoothie, and generate a code to activate a vending machine, like the vending machine 110 shown in FIGS. 1-2.

Mobile device 500 can include processor 514 for performing tasks such as signal coding, data processing, input/output processing, power control, and/or other functions, and memory 516 that can be used for storing data and/or code for running operating system 510 and/or mobile application(s) 512. Example data can include web pages, text, images, sound files, video data, or other data to be sent to and/or received from one or more network servers or other devices via one or more wired and/or wireless networks, such as the server 114 shown in FIG. 2.

Mobile device 500 can include screen 518 and camera 520. The camera 520 can include a lighting device 522. Operating system 510, application(s) 512, processor 514, and/or memory 516 can cooperate to utilize the camera 520 and the lighting device 522 to obtain images. The screen 518 can a code, such as the Q-code 324 shown in FIG. 4.

The mobile device 500 can configure and implement a global positioning system (GPS) 524. The operating system 510 and/or the application(s) 512 can communicate with the GPS 524 to obtain location data. The GPS 524 can be used by the app 512 to help a user identify a nearby vending machine.

### Exemplary Computing Devices

Referring now to FIG. 7 with continuing reference to the forgoing figures, an exemplary computing system, generally designated by the numeral 600, for use by the system 100 shown in FIGS. 1-2. The system 600 can be used to implement the cloud-based server 114 shown in FIG. 2.

The methods described herein can be implemented in hardware, software (e.g., firmware), or a combination thereof In an exemplary embodiment, the methods described herein are implemented in hardware as part of the microprocessor of a special or general-purpose digital computer, such as a personal computer, workstation, minicomputer, or mainframe computer. The system 600 therefore can include general-purpose computer or mainframe 601 capable of running multiple instances of an O/S simultaneously.

In an exemplary embodiment, in terms of hardware architecture, as shown in FIG. 7, the computer 601 includes one or more processors 605, memory 610 coupled to a memory controller 615, and one or more input and/or output (I/O) devices 640, 645 (or peripherals) that are communicatively coupled via a local input/output controller 635. The input/output controller 635 can be, for example but not limited to, one or more buses or other wired or wireless connections, as is known in the art. The input/output controller 635 can have additional elements, which are omitted for simplicity, such as controllers, buffers (caches), drivers, repeaters, and receivers, to enable communications. Further, the local interface can include address, control, and/or data connections to enable appropriate communications among the aforementioned components. The input/output controller 635 can include a plurality of sub-channels configured to access the output devices 640 and 645. The sub-channels can include fiber-optic communications ports.

The processor 605 is a hardware device for executing software, particularly that stored in storage 620, such as cache storage, or memory 610. The processor 605 can be any custom made or commercially available processor, a central processing unit (CPU), an auxiliary processor among several processors associated with the computer 601, a semiconductor based microprocessor (in the form of a microchip or chip set), a macroprocessor, or generally any device for executing instructions.

The memory 610 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 610 can incorporate electronic, magnetic, optical, and/or other types of storage media. Note that the memory 610 can have a distributed architecture, where various components are situated remote from one another, but can be accessed by the processor 605.

The instructions in memory 610 can include one or more separate programs, each of which comprises an ordered listing of executable instructions for implementing logical functions. In the example of FIG. 7, the instructions in the memory 610 a suitable operating system (OS) 611. The operating system 611 essentially controls the execution of other computer programs and provides scheduling, input-output control, file and data management, memory management, and communication control and related services. In accordance with one or more embodiments, the memory 610 and/or an I/O device 645 can be used to store the file attribute tables 630.

The memory 610 can include multiple logical partitions (LPARs) 612, each running an instance of an operating system. The LPARs 612 can be managed by a hypervisor, which can be a program stored in memory 610 and executed by the processor 605.

In an exemplary embodiment, a conventional keyboard 650 and mouse 655 can be coupled to the input/output controller 635. Other output devices such as the I/O devices 640, 645 can include input devices, for example but not limited to a printer, a scanner, microphone, and the like. Finally, the I/O devices 640, 645 can further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 600 can further include a display controller 625 coupled to a display 630. In an exemplary embodiment, the system 600 can further include a network interface 660 for coupling to a network 665. The network 665 can be an IP-based network for communication between the computer 601 and any external server, client and the like via a broadband connection. The network 665 transmits and receives data between the computer 601 and external systems.

If the computer 601 is a PC, workstation, intelligent device or the like, the instructions in the memory 610 can further include a basic input output system (BIOS) (omitted for simplicity). The BIOS is a set of essential software routines that initialize and test hardware at startup, start the OS 611, and support the transfer of data among the hardware devices. The BIOS is stored in ROM so that the BIOS can be executed when the computer 601 is activated.

When the computer 601 is in operation, the processor 605 is configured to execute instructions stored within the memory 610, to communicate data to and from the memory 610, and to generally control operations of the computer 601 pursuant to the instructions. In accordance with one or more embodiments described herein, the computer 601 can implement and/or perform the disclosed subject matter.

### Exemplary Cloud Computer System

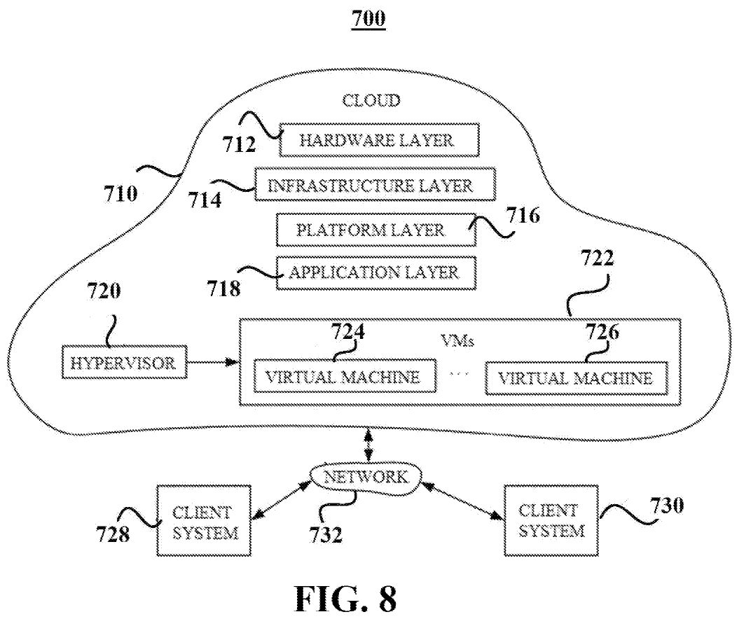

Referring now to FIG. 8 with continuing reference to the forgoing figures, exemplary cloud architecture, generally designated by the numeral 700, for use by a vending machine system, such as vending machine system 100 shown in FIGS. 1-2. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 700 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

As shown in FIG. 8, the cloud architecture 700 includes a cloud 710. The cloud 710 (or each of the different premises on the cloud 710) can include a hardware layer 712, an infrastructure layer 714, a platform layer 716, and an application layer 718.

A hypervisor 720 can illustratively manage or supervise a set of virtual machines 722 that can include a plurality of different, independent, virtual machines 724-726. Each virtual machine can illustratively be an isolated software container that has an operating system and an application inside it. It is illustratively decoupled from its host server by hypervisor 720. In addition, hypervisor 720 can spin up additional virtual machines or close virtual machines, based upon workload or other processing criteria.

A plurality of different client systems 728-730 (which can be end user systems or administrator systems, or both) can illustratively access cloud 710 over a network 732. Depending upon the type of service being used by each of the client systems 728-730, cloud 710 may provide different levels of service. In one example, the users of the different client systems are provided access to application software and databases. The cloud service then manages the infrastructure and platforms that run the application. This can be referred to as software as a service (or SaaS). The software providers operate application software in application layer 712 and end users access the software through the different client systems 728-730.

The cloud provider can also use platform layer 716 to provide a platform as a service (PaaS). This involves an operating system, programming language execution environment, database and webserver being provided to the client systems 728-730, as a service, from the cloud provider. Application developers then normally develop and run software applications on that cloud platform and the cloud provider manages the underlying hardware and infrastructure and software layers.

The cloud provider can also use infrastructure layer 714 to provide infrastructure as a service (IaaS). In such a service, physical or virtual machines and other resources are provided by the cloud provider, as a service. These resources are provided, on-demand, by the IaaS cloud provider, from large pools installed in data centers. In order to deploy applications, the cloud users that use IaaS install operating-system images and application software on the cloud infrastructure 700.

It should also be noted that architecture 700, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

Further, it should be understood that some embodiments shown in FIGS. 1-6 can be implemented through cloud infrastructure, such as the cloud infrastructure 700 shown in FIG. 8, and/or through a conventional computer system, such as the computer system 600 shown in FIG. 7. In other embodiments, computer systems and/or computing devices can be implemented within a hybrid cloud environment that includes cloud infrastructure, such as cloud infrastructure 700 shown in FIG. 8, and one or more computer systems, such computer system 600 shown in FIG. 7.

### Supported Features and Embodiments

The detailed description provided above in connection with the appended drawings explicitly describes and supports various features of a cloud-based contactless vending machine. By way of illustration and not limitation, supported embodiments include a vending machine system comprising: a vending machine having an inventory storage container holding raw materials therein, a mixer, a dispenser, and a reader; a mobile device for generating a code for the reader; and a server connecting with the vending machine over a network, the server having memory for storing computer instructions and a processor for executing the computer instructions, the computer instructions including instructions for implementing an operations management application for controlling the operations of the vending machine with a temperature control module for controlling the temperature of the vending machine; wherein the mobile device communicates to code to the vending machine reader to activate the vending system to send raw material from the inventory storage container to the mixing to form a mixture therein and to send the mixture to the dispenser for dispensing therefrom.

Supported embodiments include the foregoing vending machine system, wherein the vending machine dispenser include a plurality of drink containers and lids for packaging the mixture.

Supported embodiments include any of the foregoing vending machine systems, wherein the inventory storage container includes a plurality of silos for holding the raw materials.

Supported embodiments include any of the foregoing vending machine systems, wherein the inventory storage container includes a conveyor system for collecting the raw materials for transport to the mixer.

Supported embodiments include any of the foregoing vending machine systems, wherein the reader is a Q-Code reader.

Supported embodiments include any of the foregoing vending machine systems, wherein the operations management application includes a route planning module.

Supported embodiments include any of the foregoing vending machine systems, wherein the operations management application includes a transaction management module.

Supported embodiments include any of the foregoing vending machine systems, wherein the operations management application includes an inventory management module.

Supported embodiments include any of the foregoing vending machine systems, wherein the operations management application includes a sales management module.

Supported embodiments include any of the foregoing vending machine systems, wherein the operations management application includes a product management module.

Supported embodiments include any of the foregoing vending machine systems, wherein the vending machine includes a washer.

Supported embodiments include any of the foregoing vending machine systems, wherein the mobile device communicates the code to the reader in a contactless manner.

Supported embodiments include a method for dispensing a mixture from a vending machine system comprising: holding raw materials in an inventory storage container within a vending machine; generating a code with a mobile device to initiate a transaction with the vending machine; communicating the code to the vending machine; conveying the raw materials to a mixer within the vending machine to form the mixture; transferring the mixture to a dispenser within the vending machine, so that the vending machine can provide the mixture to a user; and communicating information relating to the transaction to a server over a network.

Supporting embodiments include the foregoing method, further comprising: controlling the vending machine with operations management software residing on the server.

Supported embodiments include a device, a system, a computer-readable storage medium, a computer program product and/or means for implementing any of the foregoing apparatus, methods, or portions thereof

The detailed description provided above in connection with the appended drawings is intended as a description of examples and is not intended to represent the only forms in which the present examples can be constructed or utilized.

It is to be understood that the configurations and/or approaches described herein are exemplary in nature, and that the described embodiments, implementations and/or examples are not to be considered in a limiting sense, because numerous variations are possible.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. A vending machine system comprising:
a vending machine having an inventory storage container holding raw materials therein, a mixer, a dispenser, and a reader;
a mobile device for generating a code for the reader; and
a server connecting with the vending machine over a network, the server having memory for storing computer instructions and a processor for executing the computer instructions, the computer instructions including instructions for implementing an operations management application for controlling the operations of the vending machine with a temperature control module for controlling the temperature of the vending machine;
wherein the mobile device communicates to code to the vending machine reader to activate the vending system to send raw material from the inventory storage container to the mixing to form a mixture therein and to send the mixture to the dispenser for dispensing therefrom.

2. The vending machine system of claim 1, wherein the vending machine dispenser include a plurality of drink containers and lids for packaging the mixture.

3. The vending machine system of claim 1, wherein the inventory storage container includes a plurality of silos for holding the raw materials.

4. The vending machine system of claim 3, wherein the inventory storage container includes a conveyor system for collecting the raw materials for transport to the mixer.

5. The vending machine system of claim 1, wherein the reader is a Q-Code reader.

6. The vending machine system of claim 1, wherein the operations management application includes a route planning module.

7. The vending machine system of claim 1, wherein the operations management application includes a transaction management module.

8. The vending machine system of claim 1, wherein the operations management application includes an inventory management module.

9. The vending machine system of claim 1, wherein the operations management application includes a sales management module.

10. The vending machine system of claim 1, wherein the operations management application includes a product management module.

11. The vending machine system of claim 1, wherein the vending machine includes a washer.

12. The vending machine system of claim 1, wherein the mobile device communicates the code to the reader in a contactless manner.

13. A method for dispensing a mixture from a vending machine system comprising:
holding raw materials in an inventory storage container within a vending machine;
generating a code with a mobile device to initiate a transaction with the vending machine;
communicating the code to the vending machine;
conveying the raw materials to a mixer within the vending machine to form the mixture;
transferring the mixture to a dispenser within the vending machine, so that the vending machine can provide the mixture to a user; and
communicating information relating to the transaction to a server over a network.

14. The method of claim 13, further comprising:
controlling the vending machine with operations management software residing on the server.
